(19) United States
(12) Patent Application Publication
(10) Pub. No.: US 2016/0336794 A1
(43) Pub. Date: Nov. 17, 2016

(54) RECHARGEABLE BATTERY

(71) Applicant: Etron Technology, Inc., Hsinchu (TW)

(72) Inventors: Shih-Min Hsu, Taipei City (TW); Chien-Cheng Kuo, Taipei City (TW)

(21) Appl. No.: 14/977,641

(22) Filed: Dec. 22, 2015

(30) Foreign Application Priority Data
May 12, 2015 (CN) 201520301822.3

(51) Int. Cl. H02J 7/34; H01M 10/46; H02J 7/00

(52) U.S. Cl. CPC H02J 7/34; H02J 7/007; H01M 10/46; H01M 2220/30

(57) ABSTRACT

A rechargeable battery includes an energy harvesting unit and an energy storage unit, wherein the rechargeable battery has a positive pole and a negative pole for coupling to an external electronic device. The energy harvesting unit is used for harvesting ionization energy. The energy storage unit is electrically connected to the energy harvesting unit and the positive pole and the negative pole of the rechargeable battery for receiving the ionization energy harvested by the energy harvesting unit. The ionization energy harvested by the energy harvesting unit is used for extending a battery life of the energy storage unit after the energy storage unit is charged by an external power source every time.

### BACKGROUND OF THE INVENTION

1. Field of the Invention

The present invention relates to a rechargeable battery, and particularly to a rechargeable battery that can utilize an energy harvesting unit to harvest ionization energy within/outside the rechargeable battery to extend a battery life of the rechargeable battery.

2. Description of the Prior Art

Nowadays, portable electronic devices have become widely popular in daily life, such as smart phones, tablet computers, digital cameras, and so on. Because a portable electronic device has a detachable rechargeable battery or a non-detachable rechargeable battery, when energy of the detachable rechargeable battery or the non-detachable rechargeable battery is exhausted, a user owing the portable electronic device can charge the detachable rechargeable battery or the non-detachable rechargeable battery again. Although the user can charge the detachable rechargeable battery or the non-detachable rechargeable battery again, when the energy of the detachable rechargeable battery or the non-detachable rechargeable battery is exhausted sometimes, the user may not immediately find a power source (e.g. an alternating current power source or a direct current power source) to charge the detachable rechargeable battery or the non-detachable rechargeable battery easily. Therefore, how to extend a battery life of the detachable rechargeable battery or the non-detachable rechargeable battery after the detachable rechargeable battery or the non-detachable rechargeable battery is charged by an external power source every time becomes an issue worth to concern.

### SUMMARY OF THE INVENTION

An embodiment of the present invention provides a rechargeable battery, wherein the rechargeable battery has a positive pole and a negative pole for coupling to an external electronic device. The rechargeable battery includes an energy harvesting unit and an energy storage unit. The energy harvesting unit is used for harvesting ionization energy. The energy storage unit is electrically connected to the energy harvesting unit and the positive pole and the negative pole of the rechargeable battery for receiving the ionization energy harvested by the energy harvesting unit.

An embodiment of the present invention provides a rechargeable battery, wherein the rechargeable battery has a positive pole and a negative pole for coupling to an external electronic device. The rechargeable battery includes an energy harvesting unit, an energy storage unit, and an energy management unit. The energy is used for harvesting unit harvesting ionization energy. The energy storage unit is electrically connected to the energy harvesting unit and the positive pole and the negative pole of the rechargeable battery for receiving the ionization energy harvested by the energy harvesting unit. The energy management unit is electrically connected to the energy harvesting unit and the energy storage unit for controlling the energy harvesting unit to charge the energy storage unit according to the ionization energy harvested by the energy harvesting unit.

The present invention provides a rechargeable battery. The rechargeable battery utilizes an energy harvesting unit of the rechargeable battery to harvest ionization energy generated within surroundings which the rechargeable battery is located in, or ionization energy generated within the rechargeable battery, or the ionization energy generated within the surroundings which the rechargeable battery is located in and the ionization energy generated within the rechargeable battery, and utilizes the ionization energy harvested by the energy harvesting unit to additionally charge an energy storage unit of the rechargeable battery. Therefore, compared to the prior art, the present invention can extend a battery life of the energy storage unit after the energy storage unit is charged by an external power source every time through the energy harvesting unit of the rechargeable battery.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a rechargeable battery according to a first embodiment of the present invention.

FIG. 2 is a diagram illustrating a rechargeable battery according to a second embodiment of the present invention.

FIG. 3 is a diagram illustrating the energy management unit simultaneously controlling the energy storage unit to provide the energy stored in the energy storage unit to the electronic device and the energy harvesting unit to provide the ionization energy harvested by the energy harvesting unit to the electronic device.

### DETAILED DESCRIPTION

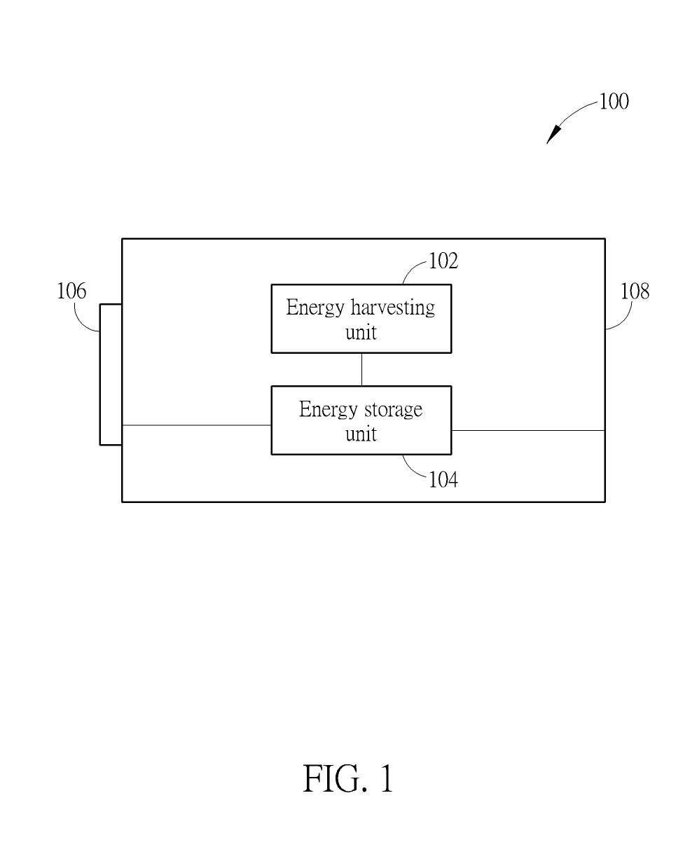

Please refer to FIG. 1. FIG. 1 is a diagram illustrating a rechargeable battery 100 according to a first embodiment of the present invention. As shown in FIG. 1, the rechargeable battery 100 includes an energy harvesting unit 102 and an energy storage unit 104, wherein the rechargeable battery 100 is a detachable rechargeable battery or a non-detachable rechargeable battery applied to an electronic device (not shown in FIG. 1), and the energy harvesting unit 102 is electrically connected to the energy storage unit 104. The energy harvesting unit 102 is used for harvesting ionization energy generated within surroundings which the rechargeable battery 100 is located in, or ionization energy generated within the rechargeable battery 100, or ionization energy generated within surroundings which the rechargeable battery 100 is located in and ionization energy generated within the rechargeable battery 100, and converting the ionization energy harvested by the energy harvesting unit 102 into electric energy, wherein the ionization energy generated within the rechargeable battery 100 includes at least one of thermal energy generated within the rechargeable battery 100, kinetic energy of the rechargeable battery 100, and electromagnetic waves within the rechargeable battery 100, and the ionization energy generated within the surroundings which the rechargeable battery 100 is located in includes at least one of thermal energy outside the rechargeable battery 100, light energy outside the rechargeable battery 100, wind energy outside the rechargeable battery 100, mechanical energy outside the rechargeable battery 100, and electromagnetic waves outside the rechargeable battery 100.

When the energy harvesting unit 102 is used for harvesting the thermal energy generated outside the rechargeable battery 100 or the thermal energy generated within the rechargeable battery 100, the energy harvesting unit 102 can be a thermal energy harvesting unit. When the energy harvesting unit 102 is a thermal energy harvesting unit, the energy harvesting unit 102 can include a thermoelectric module, so the energy harvesting unit 102 can utilize the thermoelectric module to harvest the thermal energy generated outside the rechargeable battery 100 or the thermal energy generated within the rechargeable battery 100, and convert thermal energy harvested by the energy harvesting unit 102 into electric energy. The thermoelectric module utilizes the Seebeck effect of thermoelectric phenomena to convert the thermal energy harvested by the energy harvesting unit 102 into electric energy, wherein the Seebeck effect is that when two different conductors or semiconductors form a loop, if a temperature difference exists in a junction between the two different conductors or semiconductors, the loop can generate an electromotive force corresponding to the temperature difference. That is to say, once a temperature difference exists between the thermoelectric module and the surroundings which the rechargeable battery 100 is located in, or between the thermoelectric module and the rechargeable battery 100, the thermoelectric module can generate corresponding electric energy according to the temperature difference existing between the thermoelectric module and the surroundings which the rechargeable battery 100 is located in, or between the thermoelectric module and the rechargeable battery 100.

When the energy harvesting unit 102 is used for harvesting the light energy outside the rechargeable battery 100, the energy harvesting unit 102 can include a photovoltaic module (e.g. the photovoltaic module can be at least one photovoltaic panel installed on a surface of the rechargeable battery 100), so the energy harvesting unit 102 can utilize the photovoltaic module to harvest the light energy outside the rechargeable battery 100 and convert light energy harvested by the energy harvesting unit 102 into electric energy. The photovoltaic module utilizes the Photoelectric effect to convert the light energy harvested by the energy harvesting unit 102 into electric energy, wherein a frequency of light outside the rechargeable battery 100 needs to be greater than a characteristic frequency of a metal installed in the photovoltaic module for harvesting the light outside the rechargeable battery 100. That is to say, once the frequency of the light outside the rechargeable battery 100 is greater than the characteristic frequency of the metal installed in the photovoltaic module for harvesting the light outside the rechargeable battery 100, the photovoltaic module can utilize the Photoelectric effect to convert the light outside the rechargeable battery 100 into electric energy.

When the energy harvesting unit 102 is used for harvesting kinetic energy of the rechargeable battery 100, the energy harvesting unit 102 can include a kinetic energy conversion module, so the energy harvesting unit 102 can utilize the kinetic energy conversion module to harvest the kinetic energy of the rechargeable battery 100 and convert kinetic energy harvested by the energy harvesting unit 102 into electric energy. For example, the kinetic energy conversion module can utilize electromagnetic induction to convert the kinetic energy of the rechargeable battery 100 into electric energy. That is to say, the kinetic energy conversion module can utilize the kinetic energy of the rechargeable battery 100 to make a conductor within the kinetic energy conversion module move in a magnetic field to convert the kinetic energy of the rechargeable battery 100 into electric energy.

When the energy harvesting unit 102 is used for harvesting mechanical energy outside the rechargeable battery 100, the energy harvesting unit 102 can include a piezoelectric module, wherein the piezoelectric module can convert deformation of the rechargeable battery 100 caused by mechanical energy outside the rechargeable battery 100 into electric energy (that is to say, the piezoelectric module can convert the deformation of the rechargeable battery 100 caused by the mechanical energy outside the rechargeable battery 100 into electric energy through the Piezoelectricity), so the energy harvesting unit 102 can utilize the piezoelectric module to harvest the mechanical energy outside the rechargeable battery 100 and convert mechanical energy harvested by the energy harvesting unit 102 into electric energy, wherein the Piezoelectricity is that mechanical energy and electric energy can exchange each other in a dielectric material.

When the energy harvesting unit 102 is used for harvesting wind energy outside the rechargeable battery 100, the energy harvesting unit 102 can include a fan module, so the energy harvesting unit 102 can utilize the fan module to harvest wind energy outside the rechargeable battery 100 and convert wind energy harvested by the energy harvesting unit 102 into electric energy.

When the energy harvesting unit 102 is used for harvesting electromagnetic waves outside the rechargeable battery 100 or electromagnetic waves within the rechargeable battery 100, the energy harvesting unit 102 can include a radio frequency receiving module, so the energy harvesting unit 102 can utilize at least antenna installed in the radio frequency receiving module to harvest the electromagnetic waves outside the rechargeable battery 100 or the electromagnetic waves within the rechargeable battery 100 and convert electromagnetic waves harvested by the energy harvesting unit 102 into electric energy, wherein the at least antenna installed in the radio frequency receiving module can be used for receiving at least one of 900 MHz, 1800 MHz, 2.4 GHz, and 5 GHz electromagnetic waves. In addition, the present invention is not limited to the at least antenna installed in the radio frequency receiving module receiving at least one of 900 MHz, 1800 MHz, 2.4 GHz, and 5 GHz electromagnetic waves. That is to say, the at least antenna installed in the radio frequency receiving module can also receive electromagnetic waves of other bands.

In addition, the energy harvesting unit 102 is not limited to the above mentioned thermoelectric module, photovoltaic module, kinetic energy conversion module, piezoelectric module, fan module, and radio frequency receiving module. That is to say, the energy harvesting unit 102 can also include other modules for harvesting the ionization energy generated within the surroundings which the rechargeable battery 100 is located in, or the ionization energy generated within the rechargeable battery 100, or the ionization energy generated within the surroundings which the rechargeable battery 100 is located in and the ionization energy generated within the rechargeable battery 100.

When the ionization energy (the ionization energy generated within the surroundings which the rechargeable battery 100 is located in, or the ionization energy generated within the rechargeable battery 100, or the ionization energy generated within the surroundings which the rechargeable battery 100 is located in and the ionization energy generated within the rechargeable battery 100) harvested by the energy harvesting unit 102 is greater than a predetermined value, the energy harvesting unit 102 can charge the energy storage unit 104 according to the ionization energy harvested by the energy harvesting unit 102, wherein the predetermined value can be a fixed value or changed with surplus energy stored in the energy storage unit 104. In addition, as shown in FIG. 1, the energy storage unit 104 is further electrically connected to a positive pole 106 and a negative pole 108 of the rechargeable battery 100. Because the energy harvesting unit 102 can charge the energy storage unit 104 according to the ionization energy harvested by the energy harvesting unit 102, the ionization energy harvested by the energy harvesting unit 102 can extend a battery life of the energy storage unit 104 after the energy storage unit 104 is charged by an external power source every time. In addition, in another embodiment of the present invention, the energy harvesting unit 102 can continuously charge the energy storage unit 104 according to the ionization energy harvested by the energy harvesting unit 102.

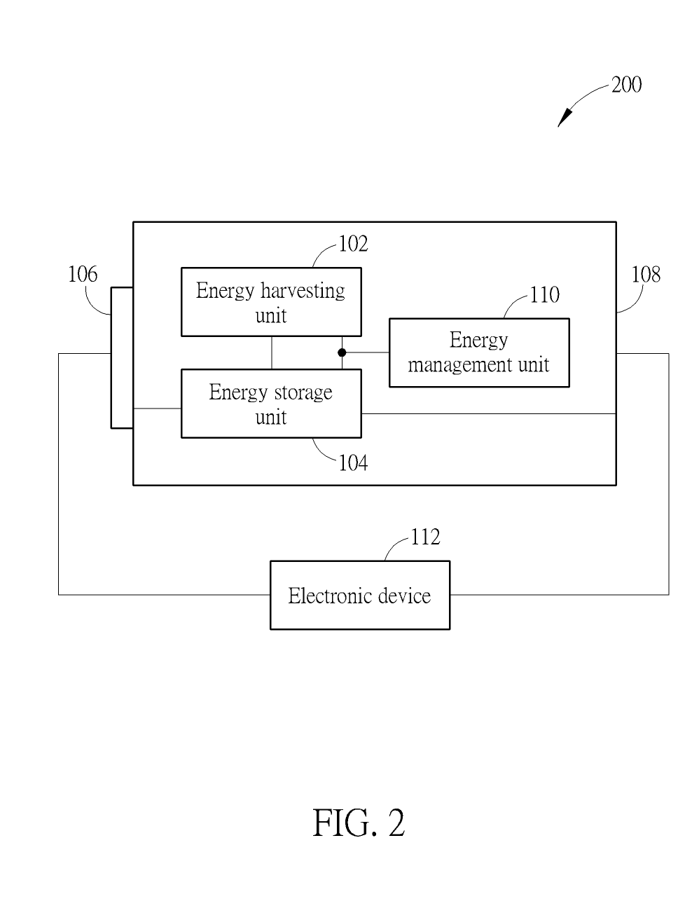

Please refer to FIG. 2. FIG. 2 is a diagram illustrating a rechargeable battery 200 according to a second embodiment of the present invention. As shown in FIG. 2, a difference between the rechargeable battery 200 and the rechargeable battery 100 is that the rechargeable battery 200 can further include an energy management unit 110. The energy management unit 110 can control the energy harvesting unit 102 to charge the energy storage unit 104 according to the ionization energy harvested by the energy harvesting unit 102 when the ionization energy harvested by the energy harvesting unit 102 is greater than the predetermined value. In addition, in another embodiment of the present invention, the energy management unit 110 can control the energy harvesting unit 102 according to the surplus energy stored in the energy storage unit 104 to charge the energy storage unit 104 according to the ionization energy harvested by the energy harvesting unit 102. In addition, in another embodiment of the present invention, the energy management unit 110 can control the energy harvesting unit 102 according to the surplus energy stored in the energy storage unit 104 and the ionization energy harvested by the energy harvesting unit 102 being greater than the predetermined value to charge the energy storage unit 104 according to the ionization energy harvested by the energy harvesting unit 102. In addition, in another embodiment of the present invention, the energy management unit 110 can continuously control the energy harvesting unit 102 to charge the energy storage unit 104 according to the ionization energy harvested by the energy harvesting unit 102.

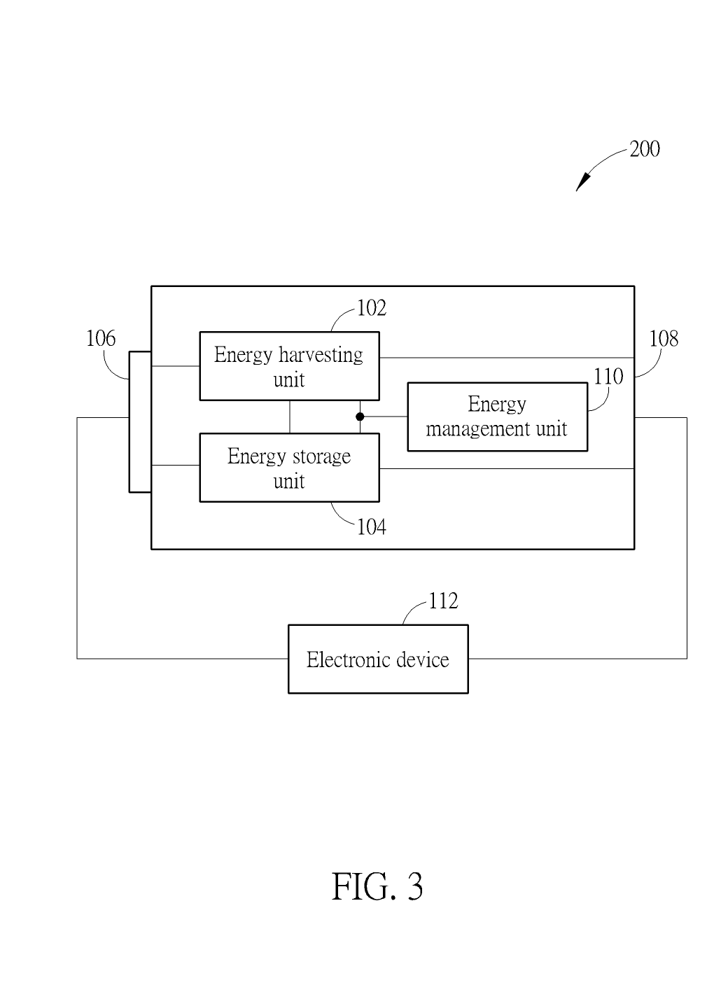

In addition, as shown in FIG. 2, the energy management unit 110 can further control the energy storage unit 104 to provide energy stored in the energy storage unit 104 to an electronic device 112 electrically connected to the rechargeable battery 200. In addition, in another embodiment of the present invention, the energy management unit 110 can simultaneously control the energy storage unit 104 to provide the energy stored in the energy storage unit 104 to the electronic device 112 and the energy harvesting unit 102 to provide the ionization energy harvested by the energy harvesting unit 102 to the electronic device 112 (as shown in FIG. 3). In addition, subsequent operational principles of the rechargeable battery 200 are the same as those of the rechargeable battery 100, so further description thereof is omitted for simplicity.

To sum up, the rechargeable battery utilizes the energy harvesting unit to harvest the ionization energy generated within the surroundings which the rechargeable battery is located in, or the ionization energy generated within the rechargeable battery, or the ionization energy generated within the surroundings which the rechargeable battery is located in and the ionization energy generated within the rechargeable battery, and utilizes the ionization energy harvested by the energy harvesting unit to additionally charge the energy storage unit. Therefore, compared to the prior art, the present invention can extend a battery life of the energy storage unit after the energy storage unit is charged by the external power source every time through the energy harvesting unit of the rechargeable battery.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A rechargeable battery, wherein the rechargeable battery has a positive pole and a negative pole for coupling to an external electronic device, the rechargeable battery comprising:
an energy harvesting unit harvesting ionization energy; and
an energy storage unit electrically connected to the energy harvesting unit and the positive pole and the negative pole of the rechargeable battery for receiving the ionization energy harvested by the energy harvesting unit.

2. The rechargeable battery of claim 1, wherein the energy harvesting unit is a thermal energy harvesting unit, a light energy harvesting unit, a wind energy harvesting unit, a mechanical energy harvesting unit, or an electromagnetic wave energy harvesting unit.

3. The rechargeable battery of claim 1, wherein when the ionization energy harvested by the energy harvesting unit is greater than a predetermined value, the energy harvesting unit charges the energy storage unit according to the ionization energy harvested by the energy harvesting unit.

4. The rechargeable battery of claim 1, wherein the energy harvesting unit continuously charges the energy storage unit according to the ionization energy harvested by the energy harvesting unit.

5. The rechargeable battery of claim 1, wherein the ionization energy harvested by the energy harvesting unit is used for extending a battery life of the energy storage unit after the energy storage unit is charged by an external power source every time.

6. The rechargeable battery of claim 1, wherein the ionization energy is ionization energy generated within the rechargeable battery, or generated within surroundings which the rechargeable battery is located in.

7. A rechargeable battery, wherein the rechargeable battery has a positive pole and a negative pole for coupling to an external electronic device, the rechargeable battery comprising:
an energy harvesting unit harvesting ionization energy;
an energy storage unit electrically connected to the energy harvesting unit and the positive pole and the negative pole of the rechargeable battery for receiving the ionization energy harvested by the energy harvesting unit; and
an energy management unit electrically connected to the energy harvesting unit and the energy storage unit for controlling the energy harvesting unit to charge the energy storage unit according to the ionization energy harvested by the energy harvesting unit.

8. The rechargeable battery of claim 7, wherein when the ionization energy harvested by the energy harvesting unit is greater than a predetermined value, the energy management unit controls the energy harvesting unit to charge the energy storage unit.

9. The rechargeable battery of claim 7, wherein the energy management unit controls the energy harvesting unit to charge the energy storage unit according to surplus energy stored in the energy storage unit.

10. The rechargeable battery of claim 7, wherein the energy management unit controls the energy harvesting unit to charge the energy storage unit according to surplus energy stored in the energy storage unit and the ionization energy harvested by the energy harvesting unit being greater than a predetermined value.

11. The rechargeable battery of claim 7, wherein the energy management unit continuously controls the energy harvesting unit to charge the energy storage unit according to the ionization energy harvested by the energy harvesting unit.

12. The rechargeable battery of claim 7, wherein the energy harvesting unit is further electrically connected to the positive pole and the negative pole of the rechargeable battery, and the energy management unit simultaneously controls the energy harvesting unit to provide the ionization energy harvested by the energy harvesting unit and the energy storage unit to provide surplus energy stored in the energy storage unit to the external electronic device.
